(19) United States
(12) Patent Application Publication
(10) Pub. No.: US 2012/0000071 A1
(43) Pub. Date: Jan. 5, 2012

(54) OFFSHORE WIND TURBINE INSTALLATION SYSTEM AND METHOD

(75) Inventor: Peter Graham Harris, Houston, TX (US)

(73) Assignee: TECHNIP FRANCE, Courbevoie (FR)

(21) Appl. No.: 13/256,444

(22) PCT Filed: Mar. 15, 2010
(86) PCT No.: PCT/US10/27306

§ 371 Date: Sep. 14, 2011

Related U.S. Application Data
(62) Division of application No. 61/161,488, filed on Mar. 19, 2009.

(51) Int. Cl. F03D 11/04; B23P 11/00; F03D 1/00

(52) U.S. Cl. 29/889; 29/700

(57) ABSTRACT

The disclosure provides a method and system for installing components for an offshore wind turbine assembly independent of cranes and derricks. The components are stored in an offshore structure, such as a Spar. After transporting the offshore structure horizontally to a site, the structure can be uprighted to a vertical orientation. A variable ballast component coupled to a tower of the wind turbine assembly can reciprocally retract the tower into the offshore structure to lower the tower, and extend the tower away from the offshore structure to raise the tower until the full quantity of blades are assembled to a turbine coupled to the tower. When the blades are stored in a peripheral fashion around the tower, the method and system provides for automatic rotational indexing of the tower as the tower and turbine retract and extend, so the turbine is progressively aligned with each blade to be installed.

### CROSS REFERENCE TO RELATED APPLICATIONS

The present application claims the benefit of U.S. Provisional Patent Application Ser. No. 61/161,488, filed Mar. 19, 2009.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The disclosure relates generally to a system and method for offshore wind turbine installation; and more specifically is related to a system and method for offshore wind turbine installation with an offshore structure, such as a floating structure.

2. Description of the Related Art

The use of offshore wide turbines is becoming an increasing feasible and desirable form of power generation. In implementing the concept of windmills, the larger the turbine motor, generally the more power is generated. Thus, massive structures are being and have been built. It is recognized that some of these structures are 50 meters (m) to 100 m tall and weigh 500 metric tonnes.

Currently, wind turbines installed offshore typically involve the use of cranes to lift the tower, turbine, and turbine blades into position. Offshore crane barges and services can be expensive. When considering multiple turbine units, the multiple lifts, and crane assets deployed, it can add considerable cost to the offshore installation when compared to land-based installation, and therefore affect overall commercial viability of the offshore wind turbine installation.

An alternative to the use of cranes is offered in US Publ. No. 2004/0169376. The technical field of the US Publ. No. 2004/0169376 is that of making, transporting, and installing wind generators for producing electricity, more particularly offshore, and in large numbers, so as to form wind “farms”. The wind generator of the US Publ. No. 2004/0169376 comprises a wind turbine, a deployable telescopic pylon or support supporting the turbine, and a gravity base supporting the pylon or support. US Publ. No. 2004/0169376 teaches that a wind turbine is preassembled on a floating structure with the blades connected to the turbine and the turbine connected to the tower. The floating structure is transported in an upright orientation with the telescopic support compacted to the site of installation. The floating structure is ballasted and becomes a gravity base that supports the preassembled wind turbine, and the telescopic support is deployed to a full length. A challenge with this kind of procedure can be the instability during the transportation and cost of installing, maintaining, and later moving the wind turbine.

There remains then a need for a offshore wind turbine and method for making the same that will improve the above challenges of current methods for offshore wind turbine installation.

### BRIEF SUMMARY OF THE INVENTION

The disclosure provides a method and system for installing components for an offshore wind turbine assembly independent of cranes and derricks. The components are stored in an offshore structure, such as a Spar. After transporting the offshore structure horizontally to a site, the structure can be uprighted to a vertical orientation. A variable ballast component coupled to a tower of the wind turbine assembly can reciprocally retract the tower into the offshore structure to lower the tower, and extend the tower away from the offshore structure to raise the tower until the full quantity of blades are assembled to a turbine coupled to the tower. When the blades are stored in a peripheral fashion around the tower, the method and system provides for automatic rotational indexing of the tower as the tower and turbine retract and extend, so the turbine is progressively aligned with each blade to be installed.

The disclosure provides a method of installing a wind turbine assembly using an offshore structure, the wind turbine assembly comprising a tower coupled to a turbine, comprising: storing the tower coupled to the turbine at least partially within the offshore structure; storing a first blade and a second blade at least partially within the offshore structure; coupling the first blade to the turbine at a first turbine position with the tower in a rotational first tower position; extending the tower coupled with the first blade from the offshore structure; rotating the turbine to a second turbine position different than the first turbine position; retracting the tower coupled to the turbine at least partially within the offshore structure; rotating the tower to the second tower position different than the first tower position; coupling a second blade to the turbine at the second turbine position with the tower at the second tower position; and extending the tower with the turbine coupled with the first blade and the second blade from the offshore structure.

The disclosure also provides a method of installing a wind turbine assembly using a offshore structure, the wind turbine assembly comprising a tower coupled to a turbine, the tower further being coupled to a variable ballast component, comprising: storing the tower coupled to the turbine at least partially within the offshore structure with the variable ballast component at least partially ballasted; storing a first blade at least partially within the offshore structure; coupling the first blade to the turbine at a first turbine position with the tower in a rotational first tower position; and extending the tower with the turbine coupled with the first blade from the offshore structure by at least partially deballasting the variable ballast component.

The disclosure further provides a wind turbine assembly installation system, comprising: an offshore structure; a tower coupled to a turbine and having a variable ballast component that is at least partially ballasted when the tower is retracted into the offshore structure and at least partially deballasted when the tower is extended from the well; and at least a first blade stored at least partially within the offshore structure, the first blade being decoupled from the tower and adapted to be coupled to the tower when the tower is at least partially retracted into the offshore structure.

### BRIEF DESCRIPTION OF THE SEVERAL VIEWS OF THE DRAWINGS

FIG. 1 is a side view schematic diagram illustrating an exemplary embodiment of a wind turbine assembly installed on an offshore structure, such as a floating structure, coupled to the seabed.

FIG. 2 is a perspective view schematic diagram of the exemplary embodiment in FIG. 1 illustrating the offshore structure with a plurality of blade wells.

FIG. 2A is an enlarged view of a tower well with tower guide rails shown in FIG. 2.

FIG. 3 is a perspective view schematic diagram illustrating the embodiment of FIG. 2 with the tower well located in the offshore structure.

FIG. 4 is a perspective view schematic diagram illustrating the offshore structure with a plurality of blade wells for storing a plurality of blades.

FIG. 5 is a schematic diagram illustrating the offshore structure with stored wind turbine components before an installation of the blades with a turbine coupled to a tower, the tower being at least partially retracted in the offshore structure, and a variable ballast component coupled to the tower.

FIG. 6 is a schematic diagram illustrating an exemplary sequence of steps for installing the wind turbine assembly.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The disclosure provides a method and system for installing components for an offshore wind turbine assembly independent of cranes and derricks. The components are stored in an offshore structure, such as a Spar. After transporting the offshore structure horizontally to a site, the structure can be uprighted to a vertical orientation. A variable ballast component coupled to a tower of the wind turbine assembly can reciprocally retract the tower into the offshore structure to lower the tower, and extend the tower away from the offshore structure to raise the tower until the full quantity of blades are assembled to a turbine coupled to the tower. When the blades are stored in a peripheral fashion around the tower, the method and system provides for automatic rotational indexing of the tower as the tower and turbine retract and extend, so the turbine is progressively aligned with each blade to be installed.

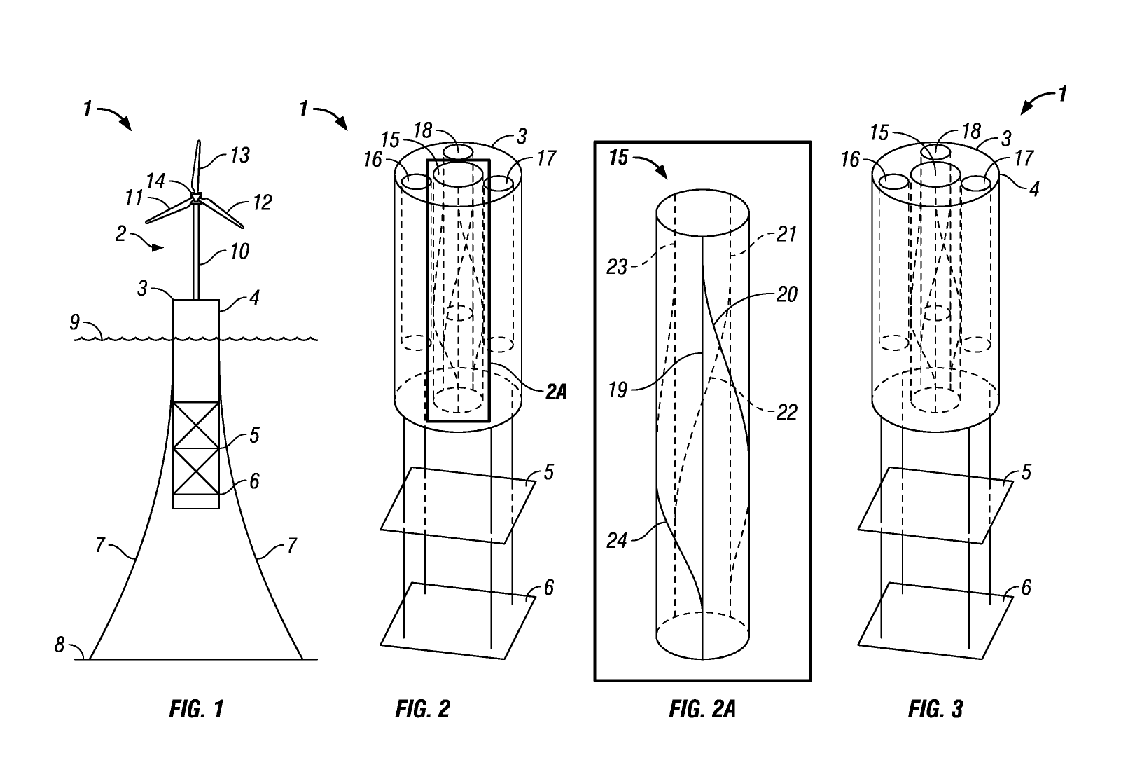

FIG. 1 is a side view schematic diagram illustrating an exemplary embodiment of a wind turbine assembly installed on an offshore structure, such as a floating structure, coupled to the seabed. A wind turbine installation system 1 includes a wind turbine assembly 2 coupled with an offshore structure 3. The wind turbine assembly 2 can include, but is not limited to, a wind generator, a wind turbine, a wind power unit (WPU), a wind energy converter (WEC), or an aerogenerator. The wind turbine assembly 2 can be coupled to the offshore structure 3 in the installed position. The wind turbine assembly 2 generally includes a tower 10, a turbine 14 coupled to the tower, and a plurality of blades 11, 12, 13 coupled to the turbine. The turbine 14 generally has a horizontal axis of rotation about which a plurality of the blades rotate. Present commercial embodiments of wind turbine assemblies often use three blades. However, the number of blades can vary. As described above in the background section, such commercial wind turbine assemblies can be massive structures that are 50 meters (m) to 100 m tall and weigh 500 metric tones. The tower 10 is designed of sufficient height and strength to support the stationary and dynamic loading of the other components. The turbine 14 is used to convert the rotational energy of the blades into electrical energy. The blades are aerodynamically designed to efficiently use wind currents to cause the turbine to rotate.

The offshore structure 3 can include, without limitation, a offshore structure, a fixedly positioned structure, a platform, a topsides, and other offshore suited structures. Examples without limitation of a floating structure include, a Spar, tension leg platform (TLP), miniaturized semi-submersible platforms, and others. For purposes of illustration, a Spar offshore structure will be illustrated with the understanding that the offshore structure can vary, as stated above, using the underlying principles disclosed herein. A Spar is a floating sea platform typically used in very deep waters. A Spar generally includes a large cylinder or hull 4 that does not extend all the way to the seabed 8, but instead is moored by a number of mooring lines 7. Typically, about 90% of the Spar hull is underwater with an upper portion for the hull providing the ability of the Spar to float above a sea surface 9. A Spar provides both a stable structure in a horizontal position, such as during transportation to the installation site, as well as a stable structure after uprighting the Spar to a vertical position for installation of the wind turbine assembly. One or more heave plates 5, 6, can be coupled to a lower part of the hull 4 that is exposed to the sea currents to reduce the vertical motion of the Spar and assist the Spar's stability when upright. Examples of Spars are disclosed in U.S. Pat. No. 5,558,467 and U.S. Pat. No. 6,817,309, which is incorporated by reference. However, those skilled in the art will recognize that any suitable offshore platform is considered within the scope of the invention.

FIG. 2 is a perspective view schematic diagram of the exemplary embodiment in FIG. 1 illustrating the offshore structure with a plurality of blade wells. FIG. 2A is an enlarged view of a tower well with tower guide rails shown in FIG. 2. FIG. 3 is a perspective view schematic diagram illustrating the embodiment of FIG. 2 with the tower well located in the offshore structure. The figures will be described in conjunction with each other.

In at least one embodiment, a tower well 15 is formed within the offshore structure 3 and particularly the hull 4. The tower well 15 can be cylindrical and can be used to store the tower 10 and turbine 14 coupled to the tower. The tower well 15 can be disposed advantageously in a transverse central portion of the hull, so that blades 11, 12, 13 can be disposed around a periphery of the offshore structure, as described below. However, it is understood that other locations of the tower well 15 can be used. Thus, for purposes herein the tower 10 and blades 11, 12, 13 are described as being stored or located at least partially within the offshore structure 3, wherein the term “within” is broadly defined to include located inside a perimeter boundary of the offshore structure or in structural reach of the offshore structure such as by outriggers or extension arms extending outward from the offshore structure.

The tower well 15 can serve to guide the tower 10 during the installation. In at least one embodiment using three blades, three vertical guide rails 19, 21, 23 are positioned around the periphery of the tower well 15, such as approximately every 120 degrees. Further, three helical guide rails 20, 22, 24 can be positioned around the periphery of the tower well 15. The vertical guide rails 19, 21, 23 can be coupled with the helical guide rails 20, 22, 24. Specially, an upper portion of the helical guide rail 20 can be coupled with an upper portion of the vertical guide rail 19 and a lower portion of the helical guide rail 20 can be coupled with a lower portion of the vertical guide rail 21. An upper portion of the helical guide rail 22 can be coupled with an upper portion of the vertical guide rail 21 and a lower portion of the helical guide rail 22 can be coupled with a lower portion of the vertical guide rail 23. An upper portion of the helical guide rail 24 can be coupled with an upper portion of the vertical guide rail 23 and a lower portion of the helical guide rail 20 can be coupled with a lower portion of the vertical guide rail 19.

Further, one or more blade wells 16, 17, 18 can be disposed about a periphery of the tower well 15. The blades 11, 12, 13 can be stored in these blade wells 16, 17, 18, such as during transportation to the installation site. The position of the blade wells can advantageously be coordinated with the spacing and position of the guide rails, such as approximately every 120 degrees if the number of blades is three and the spacing is uniformly distributed. Other numbers of guide rails and spacing of the guide rails can be used and are generally coordinated with the number of blades to be installed with the turbine. Further, non-uniform spacings can be used.

The tower can be slidably coupled with the guide rails. As the tower is extended and retracted, it traverses up and down relative to the offshore structure and specifically the tower well in this embodiment. As the tower traverses up and down, the tower can progressively engage the helical guide rails and can be automatically indexed to a new rotational tower position each cycle. The resulting rotational tower positions can be coordinated with a location of each blade that is to be coupled to the tower and specifically the turbine. In more detail, the tower can be initially coupled to a first blade at a first tower position aligned with the vertical guide rail 19. The tower can be extended using the vertical guide rail 19. As the tower is retracted back into the tower well along an upper portion of the vertical guide rail 19, the tower can engage the helical guide rail 20 and is rotated into a new indexed position of the tower (that is, a second tower position that is different than the first tower position) until engaging a lower portion of the vertical guide rail 21. At that position, advantageously, the turbine coupled to the tower is aligned to be coupled to a second blade. The second blade can be coupled to the turbine, and the tower is extended using the vertical guide rail 21. As the tower is retracted back into the tower well along an upper portion of the vertical guide rail 21, the tower can engage the helical guide rail 22 and is rotated into a new indexed position of the tower (that is, a third tower position that is different than the first tower position and second tower position) until engaging a lower portion of the vertical guide rail 23. At that position, advantageously, the turbine is aligned to be coupled to a third blade. The third blade can be coupled and the tower extended with all blades mounted. Final installation procedures can be accomplished and the wind turbine assembly can begin functioning.

If the wind turbine assembly needs to be maintained, disassembled, or moved to another site, the tower can be retracted back into the tower well along an upper portion of the vertical guide rail 23. The tower can engage the helical guide rail 24 and is rotated into a new indexed position of the tower (that is, the first tower position that is different than the second tower position and third tower position) until engaging a lower portion of the vertical guide rail 19. The turbine can be maintained, components replaced, and so forth. If one or more blades need to be replaced or otherwise disassembled, the blades can be decoupled and stored for example in the blade wells by continuing the process of retracting and extending the tower. Further, the blade can be inspected as it is retracted into the blade well or withdrawn from the blade well.

Further, the turbine will generally be rotated to new positions relative to its generally horizontal axis of rotation for each coupling of the blades. For example, the turbine will be in a first turbine position when the first blade is coupled to the turbine. Upon extending the tower with the turbine and first blade, when the assembly has sufficient clearance, the turbine will be rotated so that the turbine is in a second turbine position that can be aligned with a stored second blade for coupling thereto. The first blade would therefore not be aligned with the stored second blade. Similarly, the turbine would be rotated to a third turbine position when the tower is extended and has sufficient clearance, so that the third blade can be coupled to the turbine.

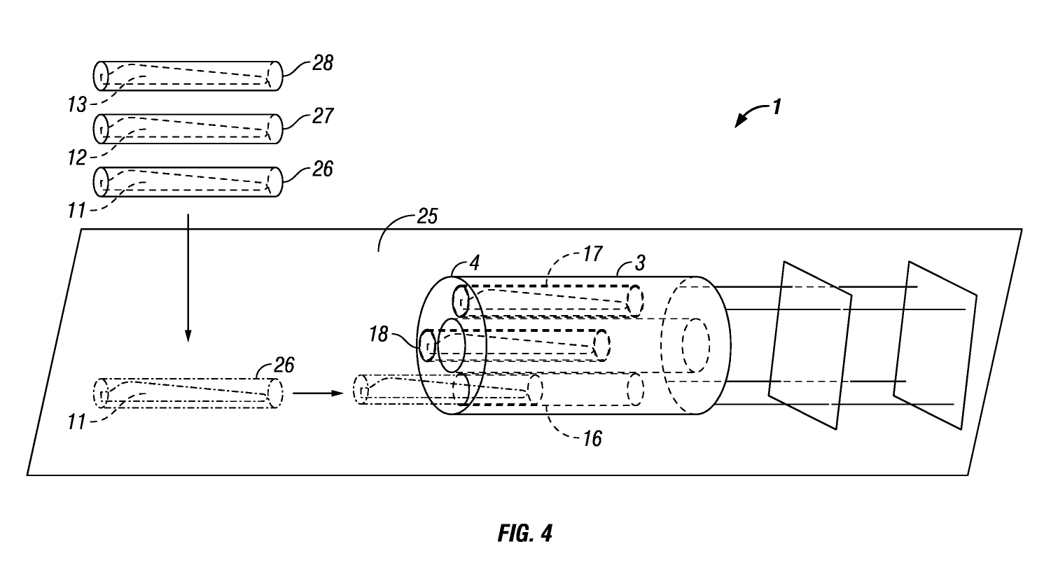

FIG. 4 is a perspective view schematic diagram illustrating an offshore structure with a plurality of blade wells for storing a plurality of blades. The offshore structure 3 can include the hull 4 with the tower well 15 and surrounding blade wells 16, 17, 18. Due to the large size, most of the fabricating for the offshore structure, the tower, blades, and other components is done is a horizontal position as shown.

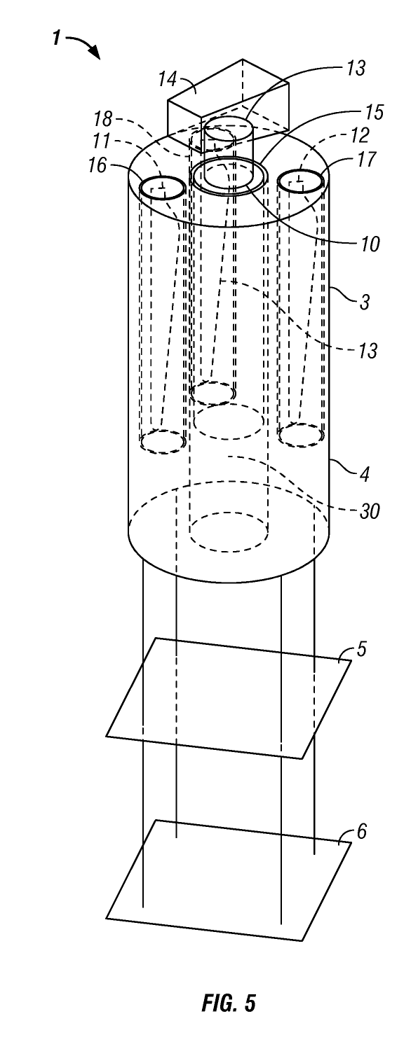

During the fabrication, typically on the fabrication yard 25, the blades 11, 12, 13 can be installed in a frame 26, 27, 28, respectively. The frame can be used to package and protect the blades. Each frame with a blade can be installed and stored on the blade wells 16, 17, 18. The blades can be oriented in the blade wells to align with an installation of the blades to the turbine at a later time. Although not expressly shown, the blade wells can also include guide rails to assist the orientation of the blade and/or frames. The tower 10 and the turbine 14 can also be installed and stored in the offshore structure 3, such as a hull 4, as shown in FIG. 5.

FIG. 5 is a schematic diagram illustrating the offshore structure with stored wind turbine assembly components before an installation of the blades with a turbine coupled to a tower, the tower being at least partially retracted in the offshore structure, and a variable ballast component coupled to the tower. In at least one embodiment, the wind turbine installation system 1 includes the offshore structure 3 with components of a wind turbine assembly 2 having a tower 10, turbine 14 coupled to the tower, and one or more blades 11, 12, 13. The tower can be stored at least partially in a retracted position within the offshore structure, specifically within the tower well 15. The blades 11, 12, 13 can be stored at least partially in a retracted position within the offshore structure, specifically at least partially in the blade wells 16, 17, 18.

Further, the wind turbine installation system 1 can include a variable ballast component 30 coupled to the tower 10. The variable ballast component 30 can be an air can or tank coupled to a lower portion of the tower, such as a bottom of the tower. By selectively ballasting (that is, flooding with fluid) the variable ballast component 30, the tower and other associated components can be retracted into the offshore structure 3. By selectively deballasting (that is, expunging fluid) the variable ballast component 30, the tower can be extended from the offshore structure 3. Other types of ballast components and ballast can be used as would be known to those in the art that can be varied in ballast to assist in retracting and extending the tower relative to the offshore platform. Water and air can be used for ballasting and deballasting as the tower is reciprocally retracted within and extended from the offshore structure. In some embodiments, it can be advantageous to provide a fluid with a different density than the water. Different density fluids can include, without limitation, heavier fluids used as “mud” drilling fluids. Such use can be especially appropriate for stability after the blades are installed, when the wind turbine assembly 2 is ready for operation.

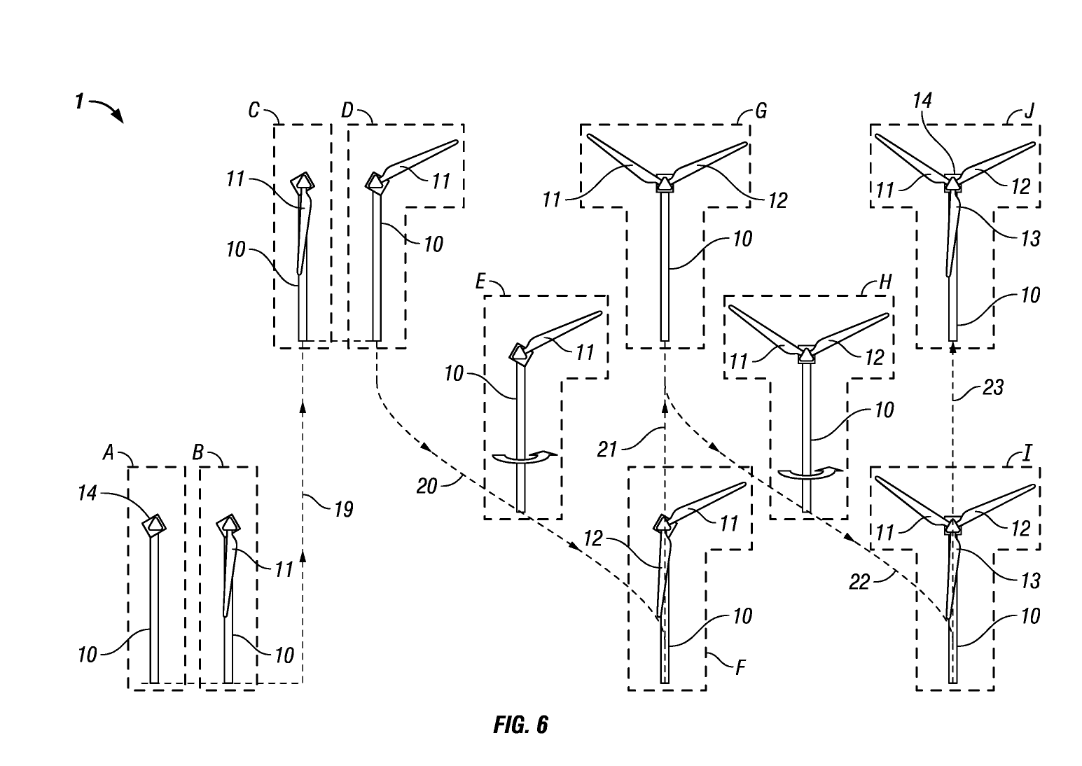

FIG. 6 is a schematic diagram illustrating an exemplary sequence of steps for installing the wind turbine assembly. In reference, for example, to FIGS. 4 and 5, the blades 11, 12, 13, the tower 10, and the turbine 14 can be stored on the offshore structure 3 as components for the wind turbine assembly 2. The wind turbine installation system 1, having the offshore structure 3 with the components for the wind turbine assembly 2, can be launched on the sea and towed, advantageously in the horizontal position, by a vessel to an offshore installation site. The installation site can include deep water. Upon arriving at its destination, the wind turbine installation system 1 can be used to install the wind turbine assembly 2. In at least one embodiment, the offshore structure, if a Spar, can be uprighted into a vertical position by customary procedures for uprighting Spars. The offshore structure can be moored or otherwise coupled to the sea bed. A series of exemplary steps 6A-6J illustrated in FIG. 6 can be used to complete the installation of the embodiment of the wind turbine assembly 2, illustrated in FIGS. 1 through 5.

Step 6A is a schematic diagram illustrating the tower 10 retracted at least partially within the offshore structure 3 (shown in FIG. 5). The turbine 14 is coupled to the tower 10 and the tower is in at least a partially retracted position in the offshore structure 3. The tower is disposed rotationally with respect to its longitudinal axis in a first tower position to align the turbine with a first blade 11 disposed in its respective blade well 16. Further, the turbine is rotationally disposed in a first turbine position so that a portion of the turbine is aligned with a first blade 11 and the first blade 11 can be coupled to the turbine.

Step 6B is a schematic diagram illustrating a first blade 11 coupled with a turbine 14 disposed in the first turbine position and the tower 10 disposed in the first tower position when the tower is disposed in at least a partially retracted position in the offshore structure. The coupling generally occurs while the blade 11 is disposed in its respective blade well 16.

Step 6C is a schematic diagram illustrating the tower 10 disposed in at least a partially extended position with the turbine 14 disposed in the first turbine position and the tower disposed in the first tower position. The tower 10 can be raised vertically in the tower well 15 of the offshore structure 3 (shown in FIG. 5) and guided along the guide rail 19 in order to withdraw the first blade 11 from the first blade well 16. In the exemplary embodiment shown in FIG. 5, the variable ballast component 30 is coupled to the tower 10 and slidably disposed within the offshore structure 3 and particularly the tower well 15. The ballast 30 can be at least partially deballasted (that is, to at least partially lessen the amount of ballast) to cause a buoyancy to the tower 10 to at least partially extend the tower from the offshore structure 3 in FIG. 5 and raise the tower in elevation. However, those skilled in the art would appreciate that any apparatus for raising the tower 10 can be used.

Step 6D is a schematic diagram illustrating the tower 10 disposed in at least a partially extended position with the turbine 14 rotated to a second turbine position and the tower disposed in the first tower position. The turbine 14 with the first blade 11 can be rotated from the first turbine position to a second turbine position. The second turbine position can rotationally align the turbine for coupling with the second blade 12, as discussed below. In the illustration, the first turbine position can be at a 6 o'clock position for the first blade 11. The turbine can be rotated so that the first blade is at a 2 o'clock position (approximately 120 degrees in the counter-clockwise direction) to establish the second turbine position at the 6 o'clock position.

Step 6E is a schematic diagram illustrating the tower 10 being retracted into the offshore structure 3 of FIG. 5 with the turbine 14 disposed in the second turbine position and the tower being rotated to a second tower position. The tower 10 can be retracted down the vertical guide rail 19. As the tower is retracted into the tower well 15, it can engage and be guided by the helical guide rail 20 in order to rotate the tower 10 approximately 120 degrees, measured in a horizontal plane, to the second tower position, until the tower engages the vertical guide rail 21. At the second tower position, the turbine 14 is generally aligned with a second blade 12 in a second blade well 17 for coupling thereto.

Step 6F is a schematic diagram illustrating the second blade 12 coupled with the turbine 14 disposed in the second turbine position and the tower 10 disposed in the second tower position when the tower is retracted. The coupling between the turbine 14 and the second blade 12 generally occurs while the blade is disposed in its respective blade well 17.

Step 6G is a schematic diagram illustrating the tower 10 in an extended position with the turbine 14 rotated to a third turbine position and the tower disposed in the second tower position. The tower 10 can be raised vertically in the tower well 15 and extended from the offshore structure to withdraw the second blade 12. The tower is guided along the vertical guide rail 21. The turbine 14 with the second blade 12 can be rotated from the second turbine position to a third turbine position. In the illustration, the second turbine position can be at a 6 o'clock position for the second blade 12 and the first blade 11 can be at a 2 o'clock position. The turbine can be rotated so that the second blade is at a 2 o'clock position (approximately 120 degrees in the counter-clockwise direction) and the first blade 11 is at a 10 o'clock position to establish the third turbine position at the 6 o'clock position.

Step 6H is a schematic diagram illustrating the tower 10 being retracted into the offshore structure with the turbine 14 disposed in the third turbine position and the tower being rotated to a third tower position. The tower 10 can be retracted down the vertical guide rail 21. As the tower is retracted into the tower well 15, it can engage and be guided by the helical guide rail 22 in order to rotate the tower 10 approximately 120 degrees horizontally to the third tower position until the tower engages the vertical guide rail 23. At the third tower position, the turbine 14 is generally aligned with a third blade 13 in a third blade well 18 for coupling thereto.

Step 6I is a schematic diagram illustrating the third blade 13 coupled with the turbine 14 disposed in the third turbine position and the tower 10 disposed in the third tower position when the tower is retracted. The coupling between the turbine 14 and the third blade 13 generally occurs while the blade is disposed in its respective blade well 18.

Step 6J is a schematic diagram illustrating the tower 10 in an extended position from the offshore platform with the plurality of blades 11, 12, 13 coupled to the turbine 14. The tower can be guided along the vertical guide rail 23 to retract the third blade 13 from the third blade well 18. The tower 10 can be secured in position with the offshore structure, additional ballast added for stability, if desired, and the remainder of the associated components, connections, and other installation needs finished, so that the wind turbine assembly can become operational, as illustrated in FIG. 1.

If the tower 10 is retracted again, the tower can be retracted down the vertical guide rail 23. As the tower is retracted into the tower well 15, it can engage and be guided by the helical guide rail 24, shown in FIG. 2, in a similar manner as has been described above with reference to the helical guide rails 20, 22. The helical guide rail 24 can rotate the tower 10 approximately 120 degrees to the first tower position until the tower engages the vertical guide rail 19.

While the illustrations above and sequence of steps have been described with three blades with corresponding three vertical guides, helical guides, blade wells, turbine positions, tower positions, and so forth, it is expressly understood that the number of blades can vary and therefore the number of components and position vary as may be appropriate.

The methods of installing the wind turbine assembly could likewise be performed in a corresponding order to disassemble the wind turbine assembly. Having the ability to disassembly the wind turbine assembly without the use of additional vessels and/or cranes offers many advantages, including but not limited to, allowing for mobility of the wind turbine assembly 2, and allowing for maintenance or repair of the wind turbine assembly 2.

Other and further embodiments utilizing one or more aspects of the inventions described above can be devised without departing from the spirit of Applicant's invention. For example, the tower can be rotated into a new tower position prior to retracting the tower at least partially within the offshore structure. The counterclockwise rotation sequence illustrated above to establish the turbine positions can be reversed to a clockwise rotation sequence. Other orientations besides the 6, 2 and 10 o'clock orientations can be used.

Further, the various methods and embodiments of the wind turbine assembly and method of installing the same can be included in combination with each other to produce variations of the disclosed methods and embodiments. Discussion of singular elements can include plural elements and vice-versa. Also, various aspects of the embodiments could be used in conjunction with each other to accomplish the understood goals of the disclosure. Unless the context requires otherwise, the word “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and may further include without limitation integrally forming one functional member with another in a unity fashion. The coupling may occur in any direction, including rotationally.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to fully protect all such modifications and improvements that come within the scope or range of equivalent of the following claims.

What is claimed is:

1. A method of installing a wind turbine assembly using an offshore structure, the wind turbine assembly having a tower coupled to a turbine, the method comprising:
storing the tower coupled to the turbine at least partially within the offshore structure;
storing a first blade and a second blade at least partially within the offshore structure;
coupling the first blade to the turbine at a first turbine position with the tower in a rotational first tower position;
extending the tower coupled with the first blade from the offshore structure;
rotating the turbine to a second turbine position different than the first turbine position;
retracting the tower coupled to the turbine at least partially within the offshore structure;
rotating the tower to the second tower position different than the first tower position;
coupling a second blade to the turbine at the second turbine position with the tower at the second tower position; and
extending the tower with the turbine coupled with the first blade and the second blade from the offshore structure.

2. The method of claim 1, further comprising:
rotating the turbine to a third turbine position different than the first turbine position and the second turbine position;
retracting the tower coupled to the turbine at least partially within the offshore structure;
rotating the tower to a third tower position different than the first tower position and the second tower position;
coupling a third blade to the turbine at the third turbine position with the tower at the third tower position; and
extending the tower with the turbine coupled with the first blade, the second blade, and the third blade from the offshore structure.

3. The method of claim 1, wherein the tower is coupled to a variable ballast component and further comprising at least partially ballasting the variable ballast component to retract the tower into the offshore structure and at least partially deballasting the ballast to extend the tower from the offshore structure.

4. The method of claim 1, wherein the offshore structure comprises a tower well in which the tower can be retracted and extended and at least a first blade well in which the first blade can be stored.

5. The method of claim 1, wherein installing the wind turbine assembly is independent of the use of a crane or a derrick.

6. The method of claim 1, wherein the extending the tower comprises using a water ballast, air system, or a combination thereof.

7. The method of claim 1, wherein the offshore structure is a Spar.

8. A method of installing a wind turbine assembly using an offshore structure, the wind turbine assembly comprising a tower coupled to a turbine, the tower further being coupled to a variable ballast component, comprising:
storing the tower coupled to the turbine at least partially within the offshore structure with the variable ballast component at least partially ballasted;
storing a first blade at least partially within the offshore structure;
coupling the first blade to the turbine at a first turbine position with the tower in a rotational first tower position; and
extending the tower with the turbine coupled with the first blade from the offshore structure by at least partially deballasting the variable ballast component.

9. The method of claim 8, further comprising:
rotating the turbine to a second turbine position different than the first turbine position;
retracting the tower coupled to the turbine at least partially within the offshore structure by at least partially ballasting the variable ballast component;
rotating the tower to a second tower position different than the first tower position;
coupling a second blade to the turbine at the second turbine position with the tower at the second tower position; and
extending the tower with the turbine coupled with the first blade and the second blade from the offshore structure by at least partially deballasting the variable ballast component.

10. The method of claim 9, further comprising:
rotating the turbine to a third turbine position different than the first turbine position and the second turbine position;
retracting the tower coupled to the turbine at least partially within the offshore structure by at least partially ballasting the variable ballast component;
rotating the tower to a third tower position different than the first tower position and the second tower position;
coupling a third blade to the turbine at the third turbine position with the tower at the third tower position; and
extending the tower with the turbine coupled with the first blade, the second blade, and the third blade from the offshore structure by at least partially deballasting the variable ballast component.

11. The method of claim 8, wherein the offshore structure comprises a tower well in which the tower can be retracted and at least a first blade well in which the first blade can be stored.

12. The method of claim 8, wherein installing the wind turbine assembly is independent of the use of a crane or derrick.

13. The method of claim 8, wherein the offshore structure is a Spar.

14. The method of claim 8, wherein the extending the tower at least partially outside of the at least one well comprises using a water ballast, air system, or a combination thereof.

15. A wind turbine installation system, comprising:
an offshore structure;
a tower coupled to a turbine and having a variable ballast component that is at least partially ballasted when the tower is retracted into the offshore structure and at least partially deballasted when the tower is extended from the well; and
at least a first blade stored at least partially within the offshore structure, the first blade being decoupled from the tower and adapted to be coupled to the tower when the tower is at least partially retracted into the offshore structure.

16. The system of claim 15, wherein:
the turbine is adapted to be rotated to a second turbine position different than the first turbine position, and the tower is adapted to be rotated to a second tower position different than the first tower position,
before a second blade is coupled to the turbine and the tower is extended with the first blade and the second blade coupled to the turbine.

17. The system of claim 16, wherein:
the turbine is adapted to be rotated to a third turbine position different than the first turbine position and the second turbine position, and the tower is adapted to be rotated to a third tower position different than the first tower position and the third tower position,
before a third blade is coupled to the turbine and the tower is extended with the first blade, the second blade, and the third blade coupled to the turbine.

18. The system of claim 15, wherein the variable ballast component comprises a water ballast, air system, or a combination thereof.

19. The system of claim 15, wherein the offshore structure comprises a tower well for the tower and at least a first blade well for the first blade.

20. The system of claim 15, wherein the variable ballast component is adapted to extend and retract the tower independent of a crane or a derrick.

21. The system of claim 15, wherein the offshore structure is a Spar.
